(19) United States
(12) Patent Application Publication
(10) Pub. No.: US 2008/0261018 A1
(43) Pub. Date: Oct. 23, 2008

(54) ARTICLES PROVIDING NON-MAGNETIC ADHERENCE TO SURFACES

(76) Inventor: Susan Russell, Carmel, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/104,062

(22) Filed: Apr. 16, 2008

Related U.S. Application Data
(60) Provisional application No. 60/912,246, filed on Apr. 17, 2007.
(60) Provisional application No. 60/944,606, filed on Jun. 18, 2007.

(51) Int. Cl. B32B 7/12; B32B 27/30

(52) U.S. Cl. 428/317.1; 428/304.4; 156/327

(57) ABSTRACT

An apparatus comprises a display item having a substantially rigid support piece and a non-magnetic adherence layer comprised of polyvinyl chloride foam configured to adhere to non-ferromagnetic surfaces. Additionally, the apparatus includes an adhesive layer applied between the adherence layer and the support piece of the display item. The adhesive layer is operable to attach the adherence layer to the support piece so that the display item may be selectively displayed on a non-ferromagnetic surface.

### REFERENCE TO RELATED APPLICATIONS

The present application claims the benefit of U.S. Provisional Patent Application Ser. No. 60/912,246 filed Apr. 17, 2007, and U.S. Provisional Patent Application Ser. No. 60/944,606 filed Jun. 18, 2007, both entitled ARTICLES PROVIDING NON-MAGNETIC ADHERENCE TO SURFACES and both of which are hereby incorporated by reference in their entireties.

### FIELD OF THE DISCLOSURE

The present invention generally relates to articles capable of providing non-magnetic adherence to surfaces, and more specifically to articles having polyvinyl chloride material backing to provide “tacky” adherence to stainless steel and other substantially non-ferromagnetic surfaces.

### BACKGROUND OF THE DISCLOSURE

Magnetic items often will not stick to certain surfaces, including glass, mirrors, stainless steel, and other surfaces commonly found in a home or office. Many times, these substantially non-ferromagnetic surfaces go unadorned due to the inability to adhere photos, papers, decorations, etc. to the surfaces. Accordingly, there remains a need for non-magnetic releasable adherence of articles to these types of surfaces.

### SUMMARY OF THE DISCLOSURE

In certain embodiments, an apparatus comprises a display item to be displayed on a non-ferromagnetic surface. The display item is substantially planar so that the display item is configured to lay substantially flat against the non-ferromagnetic surface. The apparatus further includes a material backing piece attached to the display item. The material backing piece is substantially planar and is comprised of polyvinyl chloride foam configured to adhere to non-ferromagnetic surfaces so that the display item may be selectively displayed on a non-ferromagnetic surface. Additionally, the display item is configured to be repeatedly adhered to and removed from the non-ferromagnetic surface.

In certain embodiments, an apparatus comprises a display item to be displayed on a non-ferromagnetic surface. The display item has a substantially rigid support piece and is substantially planar so that the display item is configured to lay substantially flat against the non-ferromagnetic surface. The apparatus additionally includes a substantially planar, non-magnetic adherence layer comprised of polyvinyl chloride foam configured to adhere to non-ferromagnetic surfaces. Further, the apparatus includes an adhesive layer applied between the adherence layer and the support piece of the display item, the adhesive layer being operable to attach the adherence layer to the support piece so that the display item may be selectively displayed on a non-ferromagnetic surface.

In certain embodiments, a method comprises providing a display item to be displayed on a non-ferromagnetic surface. The display item is substantially planar so that the display item is configured to lay substantially flat against the non-ferromagnetic surface. The method additionally comprises providing a substantially planar material backing piece. The material backing piece is comprised of polyvinyl chloride foam configured to adhere to non-ferromagnetic surfaces. Further, the method comprises attaching the material backing piece to the display item so that the display item may be repeatedly, selectively displayed on the non-ferromagnetic surface.

### BRIEF DESCRIPTION OF THE DRAWINGS

FIG. 1 is a side view of an article according to an embodiment of the present disclosure.

FIG. 2A is a back view of an article according to an embodiment of the present disclosure.

FIG. 2B is another back view of an article according to an embodiment of the present disclosure.

FIG. 3 includes front views of various articles according to an embodiment of the present disclosure.

### DESCRIPTION OF THE PREFERRED EMBODIMENTS

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates.

The present disclosure is directed to articles providing non-magnetic, releaseable adherence to surfaces to allow for the display of such articles. In certain embodiments, the articles can include a backing composed of polyvinyl chloride material to provide frictional or “tacky” adherence to certain surfaces. The polyvinyl chloride material backing may be useful for adherence to glass, mirrors, stainless steel, and other substantially non-ferromagnetic surfaces. Additionally, the polyvinyl chloride material backing can include an adhesive layer or coating on one side to provide for substantially permanent adhesion to the item to be displayed.

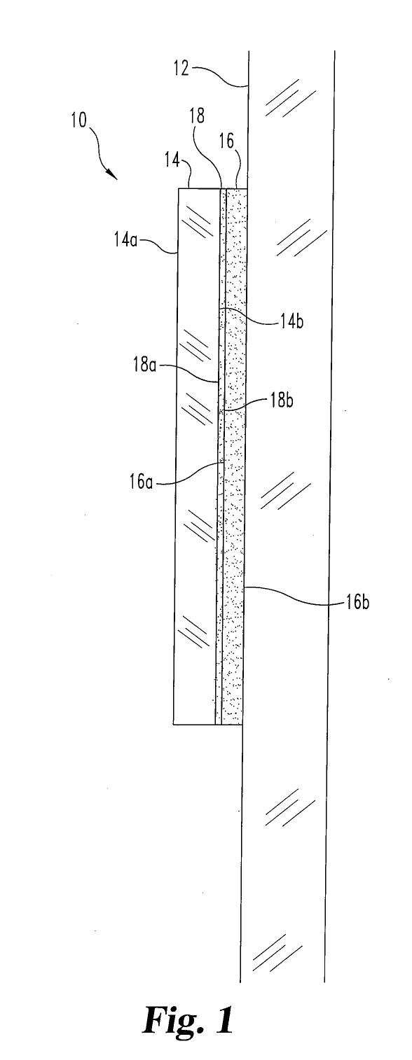

Referring to FIG. 1, there is shown a side view of an article 10 according to one embodiment of the present invention. Article 10 non-magnetically and releasably adheres to surface 12. Article 10 includes a display item 14 having a backing layer 16 composed of polyvinyl chloride material. In the illustrated embodiment, item 14 is substantially permanently attached to backing layer 16 via an adhesion coating or layer 18. Accordingly, the entire article 10, including item 14 attached to backing layer 16 via adhesion layer 18, may be selectively removed from and placed on surface 12, as often as desired by a user, for the life of the polyvinyl chloride material.

As illustrated, item 14 includes a front surface 14a and a back surface 14b, backing layer 16 includes a front surface 16a and a back surface 16b, and adhesive layer 18 includes a front surface 18a and a back surface 18b. In preferred embodiments, back surface 16b of backing layer 16 selectively and releasably adheres to surface 12. Additionally, front surface 18a of adhesive layer 18 permanently adheres to back surface 14b of item 14, and back surface 18b of adhesive layer 18 permanently adheres to front surface 16a of backing layer 16. Accordingly, front surface 14a of item 14 may be visible and on display.

In certain embodiments, back surface 14b or display item 14 is a substantially rigid backing or support piece, such as a cardboard material as an example. In such cases, the adhesive material comprising adhesive layer 18 is applied to the cardboard backing or support piece of item 14. In certain embodiments, the adhesive material may be a type of glue.

Polyvinyl chloride material, used as backing layer 16, is advantageous in its ability to releasably adhere to certain substantially non-ferromagnetic surfaces, such stainless steel, glass and mirrors, as examples. In the present disclosure, “non-ferromagnetic” refers to surfaces that are not attracted by a magnet. Polyvinyl chloride material adheres to many surfaces, yet leaves no adhesive residue on the surface upon removal of the item. Additionally, polyvinyl chloride material may be wiped down, dried and reused without affect to its adherence ability, and resists loss of adhesion due to moisture such as rain, sweat and condensation, as examples. Moreover, polyvinyl chloride material provides for sufficient adherence to certain surfaces, such that the items may remain on display for extended periods of item, while also allowing for easy removal and re-adherence of the items as desired. To that end, the polyvinyl chloride material allows for the items to be repeatedly adhered to and removed from the non-ferromagnetic without substantial loss to its adherence ability. In the present disclosure, the polyvinyl chloride material used as backing layer 16 is a sufficiently flexible piece of polyvinyl chloride foam or sponge material.

Polyvinyl chloride material is substantially resistant to ultraviolet rays, most solvents and chemicals, fungi, oxidation and weathering. Additionally, polyvinyl chloride material is a long-life material which retains the ability to adhere to certain surfaces for an extended period of time. Polyvinyl chloride material is advantageous as a backing layer due to its numerous beneficial properties, including its adherence ability, stiffness, strength and weight, as examples. In certain embodiments, the polyvinyl chloride material used as backing layer 16 may include a quantity of plasticizing agent incorporated therein to soften the material and increase its adherence capabilities.

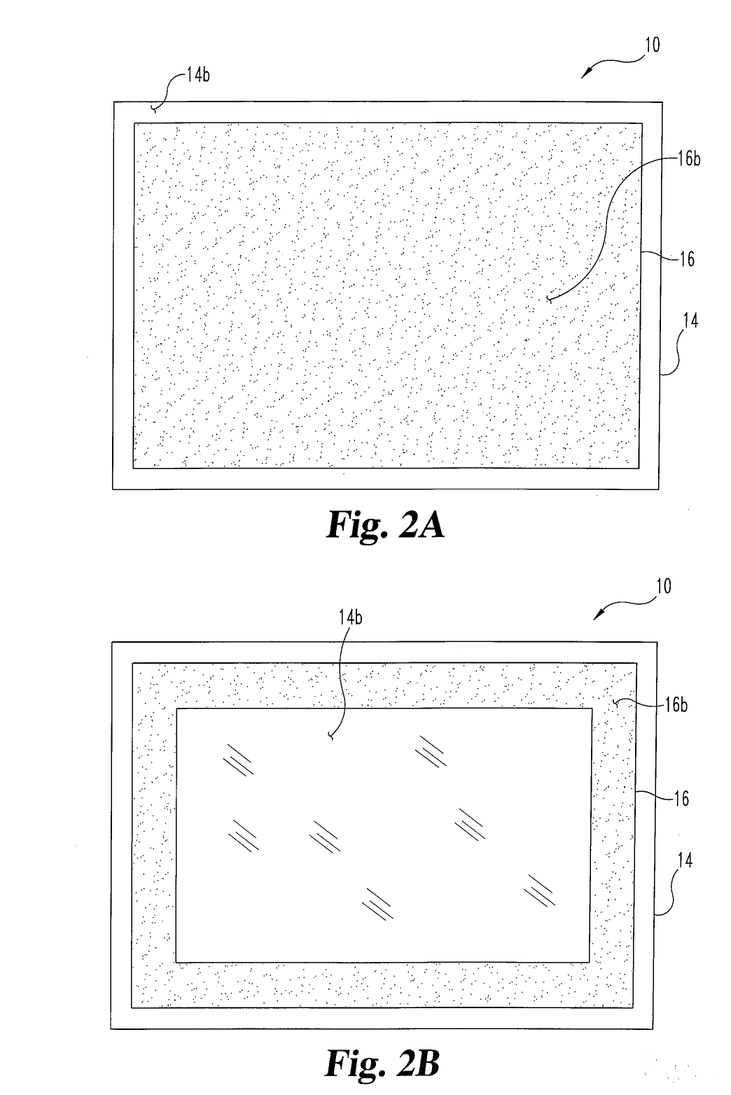

It is contemplated that the amount of backing layer 16 that is substantially permanently adhered to item 14 may vary. As illustrated in FIG. 2A, backing layer 16 may substantially cover back surface 14b of item 14. In certain other embodiments, as illustrated in FIG. 2B, backing layer 16 may include relatively thin strips of polyvinyl chloride material positioned adjacent the perimeter of item 14 on back surface 14b. To that end, it should be appreciated that backing layer 16 may be positioned on back surface 14b of item 14 in various other manners and configurations. In certain embodiments, it may be desirable to provide an increased surface area of backing layer 16 to increase the strength and integrity of the adherence of item 14 to the particular surface. Additionally, it is contemplated that adhesion layer 18 may be composed of various substantially permanent adhesion compositions and/or materials as would generally occur to one skilled in the art, to provide for the substantially permanent adhesion of backing layer 16 to item 14.

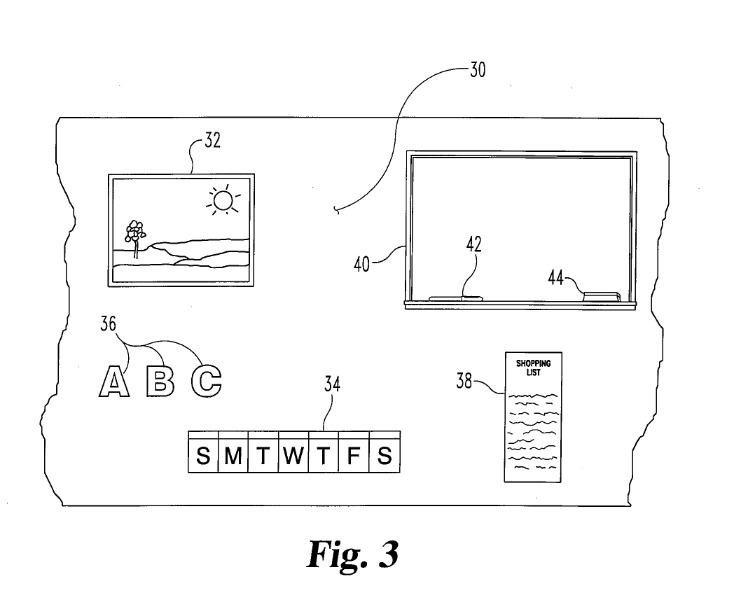

FIG. 3 illustrates only a few examples of the numerous items that may be displayed on a surface, including various substantially non-ferromagnetic surfaces, via a backing layer formed of polyvinyl chloride material. In the illustrated embodiment, photo frame 32, medicine pill box 34, alphabet letters 36, notepad 38 and dry erase board 40 are adhered to stainless steel refrigerator surface 30 via backing layers of polyvinyl chloride material. The photo frame may include a substantially rigid cardboard support backing, with a material overlay piece attached to the cardboard support backing. In certain embodiments, the material overlay piece can be imprinted with a desired design using a silk screening process. Additionally, in certain embodiments the dry erase board includes a pen 42 and an erase 44 magnetically adhered to the board.

In preferred embodiments, the displayed items are substantially planar such that they are configured to lay substantially flat against the non-ferromagnetic surface. The substantially planar configuration of the displayed items assists in preventing the items from being accidentally knocked off the non-ferromagnetic surface, as items which stick farther out from the surface having an increased chance of being accidentally knocked off. Additionally, the substantially planar configuration provides for increased surface area contact of the polyvinyl chloride foam backing layer on the item with the non-ferromagnetic surface to provide increased adherence of the display item to the surface.

In certain embodiments, various articles having regular geometric shapes may be adhered to certain surfaces via polyvinyl chloride material backing layers. Examples of such articles include, but are clearly not limited to, framed articles, picture frames, bulletin boards, dry erase boards, chalk boards, paper note pads and children's reward charts. Additionally, in certain embodiments, container articles may be adhered to certain surfaces via polyvinyl chloride material backing layers. The container articles may include, as examples only, spice jars, medicine pill boxes, vitamin jars, salt and pepper containers, facial tissue boxes, writing instrument holders, and open containers for holding letters and other mail. In some embodiments, irregularly shaped articles may be adhered to certain surfaces via polyvinyl chloride material backing layers. Such articles might include alphanumeric character sets, decorative items, holiday decorations, children's characters, irregularly shaped note pads, thermometers, and other such irregularly shaped articles which lend themselves to surface adherence via polyvinyl chloride material backing layers.

In alternative embodiments, backing layer 16 may be composed of a type of silicone tape material to provide the frictional or “tacky” adherence to non-ferromagnetic surfaces. In addition to the polyvinyl chloride foam material, the silicone tape backing may be useful for adherence to glass, mirrors, stainless steel, and other substantially non-ferromagnetic surfaces. Similar to the embodiment described above, the silicone tape backing can include an adhesive coating or layer 18 on one side to provide for substantially permanent adhesion to the item 14 to be displayed.

Silicone tape material is also advantageous in its ability to releasably adhere to certain substantially non-ferromagnetic surfaces, such stainless steel, glass and mirrors, as examples. Silicone tape material adheres to many surfaces, yet leaves no adhesive residue on the surface upon removal of the item. Additionally, silicone tape material may be wiped down, dried and reused without affect to its adherence ability, and resists loss of adhesion due to moisture such as rain, sweat and condensation, as examples. Moreover, silicone tape material provides for sufficient adherence to certain surfaces, such that the items may remain on display for extended periods of item, while also allowing for easy removal and re-adherence of the items as desired.

In certain embodiments, a type of silicone tape material which may be used is a white silicone rubber-coated glass fabric with a high temperature silicone adhesive. In such embodiments, the silicone tape material may include an inner layer of tightly woven fiberglass which is impregnated with silicone rubber. Additionally, a silicone adhesive may be coated onto one side of the inner layer. In certain embodiments, the silicone tape material may further include one or more layers of silicone rubber on opposite sides of the inner impregnated layer. The silicone adhesive provides excellent adhesion at varying temperatures, yet removes from surfaces cleanly. Silicone tape material is advantageous as a backing layer due to its numerous beneficial properties, including its adherence ability, stiffness and strength, as examples. The silicone tape material may be used to display numerous different items, such as those mentioned above, on substantially non-ferromagnetic surfaces, with only a few of the numerous possible items being illustrated in FIG. 3 as examples.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed is:

1. An apparatus, comprising:
a display item to be displayed on a non-ferromagnetic surface, wherein said display item is substantially planar so that said display item is configured to lay substantially flat against the non-ferromagnetic surface; and
a material backing piece attached to said display item, wherein said material backing piece is substantially planar and is comprised of polyvinyl chloride foam configured to adhere to non-ferromagnetic surfaces so that said display item may be selectively displayed on a non-ferromagnetic surface, wherein said display item is configured to be repeatedly adhered to and removed from the non-ferromagnetic surface.

2. The apparatus of claim 1, wherein said material backing piece is attached to said display item via an adhesive material.

3. The apparatus of claim 1, wherein said display item is a picture frame including a cardboard support piece.

4. The apparatus of claim 3, wherein said material backing piece is attached to said cardboard support piece via an adhesive material.

5. The apparatus of claim 3, wherein said picture frame further includes a cloth material overlay attached to said cardboard support piece.

6. The apparatus of claim 1, wherein said display item is a notepad.

7. The apparatus of claim 1, wherein said display item is a dry erase board.

8. An apparatus, comprising:
a display item to be displayed on a non-ferromagnetic surface, wherein said display item has a substantially rigid support piece and is substantially planar so that said display item is configured to lay substantially flat against the non-ferromagnetic surface;
a substantially planar, non-magnetic adherence layer comprised of polyvinyl chloride foam configured to adhere to non-ferromagnetic surfaces; and
an adhesive layer applied between said adherence layer and said support piece of said display item, said adhesive layer being operable to attach said adherence layer to said support piece so that said display item may be selectively displayed on a non-ferromagnetic surface.

9. The apparatus of claim 8, wherein said display item is a picture frame.

10. The apparatus of claim 9, wherein said picture frame includes a cloth material overlay attached to said support piece.

11. The apparatus of claim 8, wherein said display item is a notepad.

12. The apparatus of claim 8, wherein said support piece is comprised of a cardboard material.

13. The apparatus of claim 8, wherein said display item is a dry erase board.

14. A method, comprising:
providing a display item to be displayed on a non-ferromagnetic surface, wherein said display item is substantially planar so that said display item is configured to lay substantially flat against the non-ferromagnetic surface;
providing a substantially planar material backing piece, wherein said material backing piece is comprised of polyvinyl chloride foam configured to adhere to non-ferromagnetic surfaces; and
attaching said material backing piece to said display item so that said display item may be repeatedly, selectively displayed on the non-ferromagnetic surface.

15. The method of claim 14, further comprising selectively attaching said display item to a non-ferromagnetic surface.

16. The method of claim 15, further comprising continually attaching and removing said display item to a non-ferromagnetic surface.

17. The method of claim 14, wherein said display item is a notepad.

18. The method of claim 14, wherein said display item is a picture frame.

19. The method of claim 18, wherein said picture frame includes a cardboard support piece, wherein said attaching includes attaching said material backing piece to said cardboard support piece via an adhesive material.

20. The method of claim 19, wherein said picture frame further includes a cloth material overlay attached to said cardboard support piece.
